(19) United States
(12) Patent Application Publication
(10) Pub. No.: US 2016/0005264 A1
(43) Pub. Date: Jan. 7, 2016

(54) METHOD AND APPARATUS FOR PROVIDING SLOT MACHINE GAME

(71) Applicant: NHN Entertainment Corporation, Seongnam-si (KR)

(72) Inventors: Seong Joon ANN, Seongnam-si (KR); Wonki KIM, Seongnam-si (KR)

(21) Appl. No.: 14/790,500

(22) Filed: Jul. 2, 2015

(30) Foreign Application Priority Data
Jul. 3, 2014 (KR) 10-2014-0082912

(51) Int. Cl. G07F 17/32; G07F 17/34

(52) U.S. Cl. CPC G07F 17/3213; G07F 17/34

(57) ABSTRACT

Provided is a method and apparatus for providing a slot machine game. A game providing method executed by a game providing apparatus, the method including: setting, by an appearance probability setter, appearance probabilities of symbols for each reel in a virtual reel strip, the virtual reel strip including a plurality of reels, each of the plurality of reels including a plurality of slots, respectively; generating, by a reel strip generator, the virtual reel strip by allocating symbols determined based on the set appearance probabilities, the symbols for each reel being arranged randomly to correspond to slots included in the respective reel; and providing the generated virtual reel strip to be displayed at a display, the generated virtual reel strip being configured to spin and stop each reel in response to a spin request signal. The virtual reel strip is regenerated for each user.

### CROSS-REFERENCE TO RELATED APPLICATION

This application claims priority from and the benefit of Korean Patent Application No. 10-2014-0082912, filed on Jul. 3, 2014, which is hereby incorporated by reference for all purposes as if fully set forth herein.

### BACKGROUND

1. Field

Exemplary embodiments relate to a method and apparatus for providing a slot machine game.

2. Discussion of the Background

A slot machine refers to an electronic device or a mechanical device that provides a credit for playing a slot machine game in response to coins inputted into a coin slot and sequentially displays symbols for a chance of winning a prize.

For example, a mechanical slot machine may control a cylinder, called a reel, on which symbols are drawn, with a lever of the mechanical slot machine. When a plurality of reels rotates and then stops, symbols drawn on the reels may be aligned into a single combination. A user wins a prize based on the combination.

Also, a slot machine may be configured as an electronic device. For example, the slot machine including a display may display symbols on the display in response to the rotation and stopping of reels, and may offer a user rewards based on a combination of the symbols.

Further, a slot machine may be configured as an online game. For example, an entire virtual slot machine or a portion thereof may be configured as an online game and provided to users over a network.

A slot machine in a form of an electronic device or an online game may use a method of designating a probability based on a symbol unit of a slot or may use a fixed reel strip. For example, a slot machine may be programmed so that a probability is set based on a symbol unit of a slot, and symbols appear based on the probability instead of using a reel strip indicating entire combinations of symbols. According to a different configuration, a slot machine may be programmed so that symbols of a reel strip are provided in a fixed form, for example, a form of a reel strip in which entire combinations of symbols are predetermined.

In the configuration using a probability, a reel strip is not used and thus, it may not be possible to generate a reel strip in an intended form, such as a super stack, for example, a symbol alignment form in which all of the symbols sequentially appear on the same reel. In the configuration using a fixed reel strip, if a user observes the reel strip for long hours, all the combinations of the reel strip may be verified by the user.

FIG. 1 illustrates a portion of a mechanical reel strip according to the related art. Referring to FIG. 1, a box 110 indicated with dotted lines refers to a portion of the reel strip. Here, symbols are drawn on three reels. The box 110 expresses symbols to be displayed for a user. For example, in the case of a mechanical device, symbols may move along the physical rotation of actual reels, and symbols to be displayed when the rotation of the reels stops may be determined. Dissimilar to the mechanical device, since a slot machine configured as an electronic device or an online game electronically displays the symbols on a display based on programming, the physical rotation of reels is not required. Symbols may be controlled to be displayed on a screen based on programming.

In the configuration using a reel strip, a fixed reel strip is used in which combinations of symbols are predetermined. Accordingly, if a user observes the reel strip for long hours, the user may verify all the combinations of the reel strip.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a game providing method and apparatus that may provide a game in which users may not verify all combinations of a reel strip by, when generating a reel strip based on a predetermined pattern, regenerating and thereby providing the reel strip for each user.

Exemplary embodiments also provide a game providing method and apparatus that may uniformly maintain an entire payout rate when generating and providing a reel strip for each standard.

Additional aspects will be set forth in the detailed description which follows, and, in part, will be apparent from the disclosure, or may be learned by practice of the inventive concept.

An exemplary embodiment discloses a game providing method executed by a game providing apparatus, the method including: setting, by an appearance probability setter, appearance probabilities of symbols for each reel in a virtual reel strip, the virtual reel strip including a plurality of reels, each of the plurality of reels including a plurality of slots, respectively; generating, by a reel strip generator, the virtual reel strip by allocating symbols determined based on the set appearance probabilities, the symbols for each reel being arranged randomly to correspond to slots included in the respective reel; and providing the generated virtual reel strip to be displayed at a display, the generated virtual reel strip being configured to spin and stop each reel in response to a spin request signal. The virtual reel strip is regenerated for each user.

The game providing method may further include detecting a change of a user through a sensor included in the game providing apparatus, and regenerating the virtual reel strip in response to detecting the change of the user.

The game providing method may further include regenerating the virtual reel strip for the user every time the user logs in using a terminal.

The game providing method may further include displaying a portion of combinations of symbols determined based on the generated virtual reel strip on a screen of the game providing apparatus.

The game providing method may further include providing the generated virtual reel strip to a terminal of a user. A portion of combinations of symbols determined based on the virtual reel strip may be displayed on a screen of the terminal of the user.

A game may proceed through a combination of symbols located at a reference location according to a movement or a rotation of the virtual reel strip in response to an input of a user, and the movement or the rotation of the virtual reel strip may start from a state in which a slot randomly selected from the slots included in the virtual reel strip is located at the reference location.

An exemplary embodiment also discloses a game providing method executed by a game providing apparatus, the method including: setting, by an appearance probability setter, appearance probabilities of symbols for each reel in a virtual reel strip, the virtual reel strip including a plurality of reels, each of the plurality of reels including a plurality of slots, respectively; generating, by a reel strip generator, the virtual reel strip by allocating symbols determined based on the set appearance probabilities, the symbols for each reel being arranged randomly to correspond to slots included in the respective reel; and providing the generated virtual reel strip to be displayed at a display, the generated virtual reel strip being configured to spin and stop each reel in response to a spin request signal. Virtual reel strip is regenerated for a same user every time the same user logs in.

An exemplary embodiment also discloses a non-transitory computer-readable medium comprising a program that causes a slot game providing apparatus to perform setting, by an appearance probability setter, appearance probabilities of symbols for each reel in a virtual reel strip, the virtual reel strip including a plurality of reels, each of the plurality of reels including a plurality of slots, respectively; generating, by a reel strip generator, the virtual reel strip by allocating symbols determined based on the set appearance probabilities, the symbols for each reel being arranged randomly to correspond to slots included in the respective reel; and providing the generated virtual reel strip to be displayed at a display, the generated virtual reel strip being configured to spin and stop each reel in response to a spin request signal. The virtual reel strip is regenerated for each user.

An exemplary embodiment also discloses a game providing apparatus including: an appearance probability setter configured to set appearance probabilities of symbols for each reel in a virtual reel strip, the virtual reel strip including a plurality of reels, each of the plurality of reels including a plurality of slots, respectively; a reel strip generator configured to generate the virtual reel strip by allocating symbols determined based on the set appearance probabilities, the symbols for each reel being arranged randomly to correspond to slots included in the respective reel; and a reel strip provider configured to provide the generated virtual reel strip to be displayed at a display, the generated virtual reel strip being configured to spin and stop each reel in response to a spin request signal. The virtual reel strip is regenerated for each user.

An exemplary embodiment also discloses a game providing apparatus including: an appearance probability setter configured to set appearance probabilities of symbols for each reel in a virtual reel strip, the virtual reel strip including a plurality of reels, each of the plurality of reels including a plurality of slots, respectively; a reel strip generator configured to generate the virtual reel strip by allocating symbols determined based on the set appearance probabilities, the symbols for each reel being arranged randomly to correspond to slots included in the respective reel; and a reel strip provider configured to provide the generated virtual reel strip to be displayed at a display, the generated virtual reel strip being configured to spin and stop each reel in response to a spin request signal. The virtual reel strip is regenerated for a same user every time the same user logs in.

According to an exemplary embodiment, it is possible to provide a game in which users may not be able to verify all combinations of a reel strip by, when generating a reel strip based on a predetermined pattern, regenerating and thereby providing the reel strip for each user.

According to an exemplary embodiment, it is possible to uniformly maintain an entire payout rate when generating and providing a reel strip for each standard.

It is to be understood that both the foregoing general description and the following detailed description are exemplary and explanatory and are intended to provide further explanation of the disclosure as claimed.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 illustrates a portion of a reel strip according to the related art.

FIG. 2 and FIG. 3 illustrate a method of generating a reel strip according to an exemplary embodiment.

FIG. 4 illustrates a moving or rotating process of a virtual reel strip according to an exemplary embodiment.

FIG. 5 is a block diagram illustrating a configuration of a game providing apparatus configured in a form of an electronic device according to an exemplary embodiment.

FIG. 6 is a flowchart illustrating a game providing method according to an exemplary embodiment.

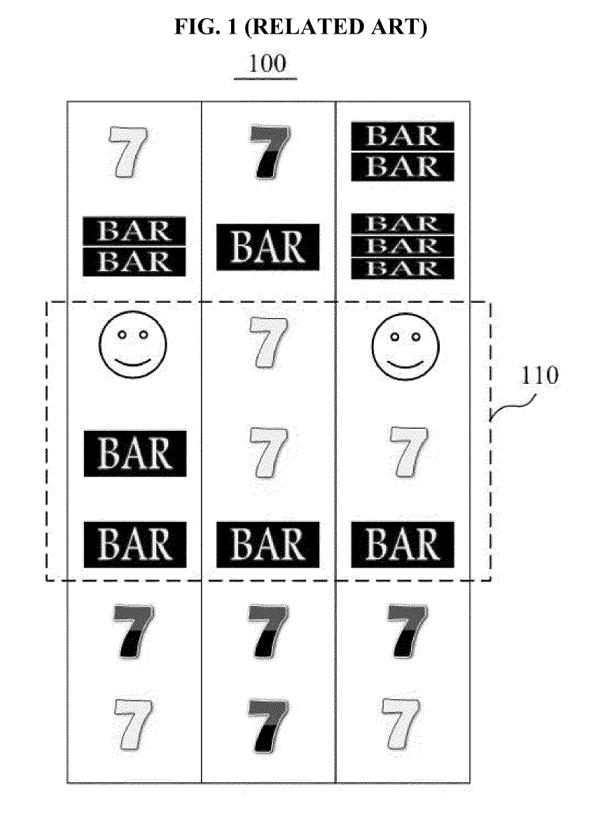

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

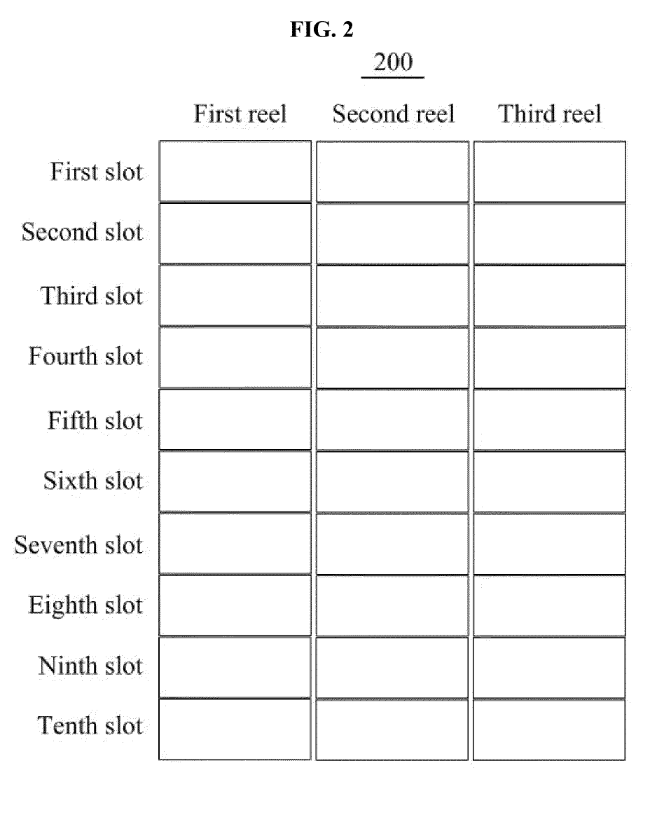

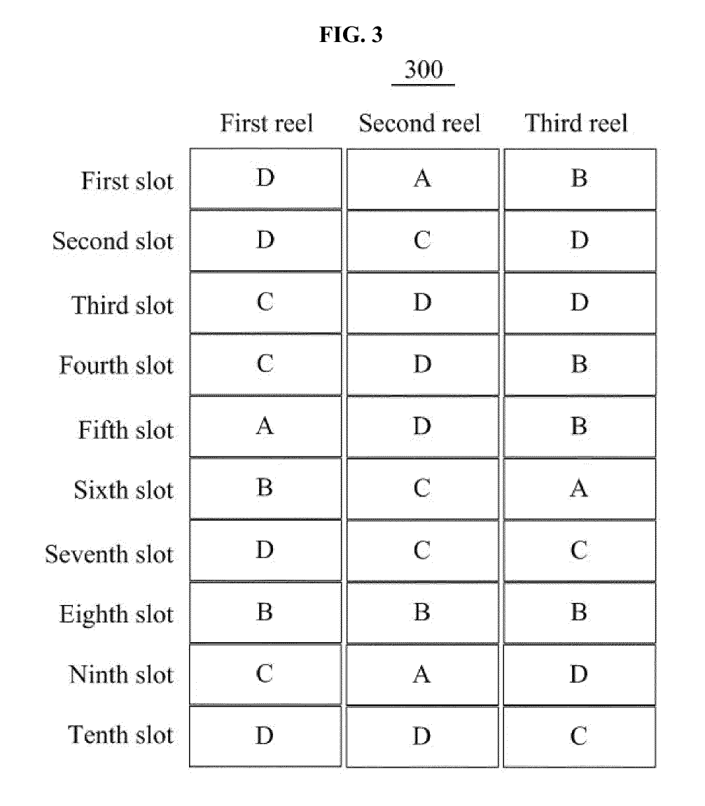

FIG. 2 and FIG. 3 illustrate a method of generating a reel strip according to an exemplary embodiment. FIG. 2 illustrates an example in which a reel strip 200 includes three reels, e.g., a first reel, a second reel, and a third reel, and each reel includes ten slots, e.g., first through tenth slots, and FIG. 3 illustrates an example in which a reel strip 300 includes three reels, e.g., a first reel, a second reel, and a third reel, and each reel includes ten slots, e.g., first through tenth slots. In an actual slot machine, a large number of slots, for example, 300 slots may be used. Herein, for a concise description, an exemplary embodiment will be described using the reel strips 200 and 300, each including three reels, each reel including ten slots. Further, for a concise description, an example is described in which a total of four symbols, A, B, C, and D, may be displayed in slots. The reel strip 200 of FIG. 2 represents slots to which symbols are not yet assigned, and the reel strip 300 of FIG. 3 represents slots to which symbols are assigned.

A game providing apparatus according to an exemplary embodiment may set appearance probabilities of a plurality of symbols, e.g., four symbols, for each reel. For example, the appearance probabilities may be set as expressed by Table 1.

TABLE 1

| | First reel | Second reel | Third reel |
|---|---|---|---|
| A | 10% | 20% | 10% |
| B | 20% | 10% | 40% |
| C | 30% | 30% | 20% |
| D | 40% | 40% | 30% |

Referring to Table 1, the symbol A may appear on the first reel, with the probability of 10%, and the symbol B may appear on the first reel, with the probability of 20%. For example, if a single reel includes ten slots, symbol A having the appearance probability of 10% may correspond to a single slot and symbol B having the appearance probability of 20% may correspond to two slots. Locations of each symbol may be randomly determined in the corresponding reel, which will be described later in more detail.

According to an exemplary embodiment, the game providing apparatus may assign symbols corresponding to slots of each reel so that the symbols may appear based on the set appearance probabilities. The location of a corresponding slot may be randomly set. FIG. 3 illustrates the reel strip 300 in which symbols A, B, C and D randomly correspond to the slots based on the set appearance probabilities. For example, in the first reel including ten slots, a single set of symbol A, two sets of symbol B, three sets of symbol C, and four sets of symbol D are randomly aligned in the reel.

More specifically, the game providing apparatus may generate a reel strip, e.g., the reel strip 300 of FIG. 3, by setting appearance probabilities of symbols for each reel, and by making the symbols correspond to slots included in each reel based on the set appearance probabilities.

Although an example in which four symbols correspond to a reel strip, such as the reel strips 200 and 300, including three reels and each reel including ten slots, is described with reference to FIGS. 2 and 3, the number of symbols, the number of reels, and/or the number of slots may vary without departing from the scope of the inventive concept.

A reel strip according to an exemplary embodiment may be a virtual reel strip. A game may be played according to a combination of symbols located on a display area in response to the virtual reel strip moving or rotating and then stopping. According to an exemplary embodiment, when moving or rotating the virtual reel strip, the game providing apparatus may move or rotate the virtual reel strip based on a slot randomly selected from slots included in the corresponding virtual reel strip.

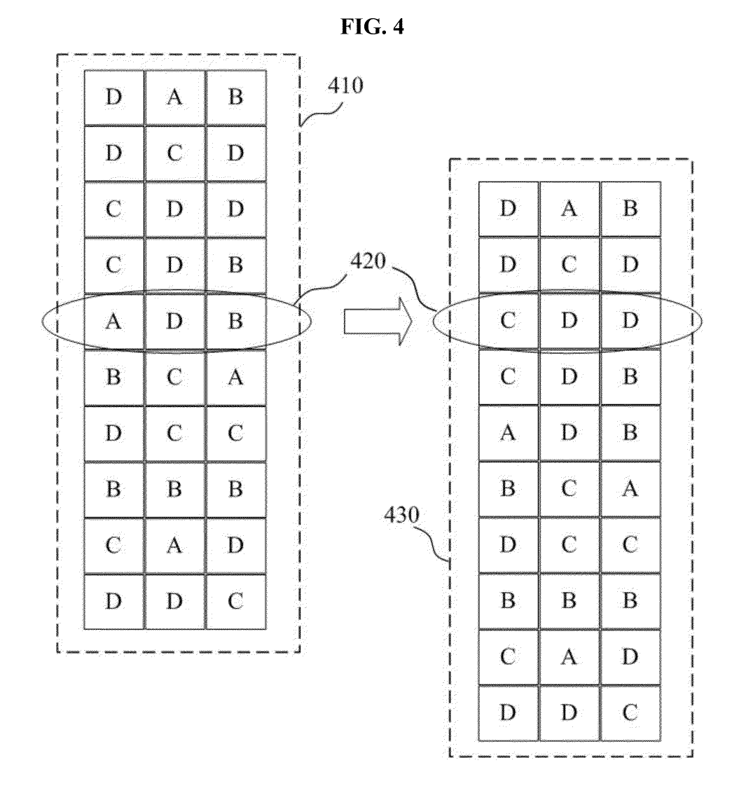

FIG. 4 illustrates a moving or rotating process of a virtual reel strip according to an exemplary embodiment. Referring to FIG. 4, a first box 410 indicated with dotted lines refers to an example in which a combination ‘ADB’ of symbols of a virtual reel strip is located at a reference location 420. The game providing apparatus may move or rotate the virtual reel strip to locate randomly selected slots at the reference location 420, prior to moving or rotating the virtual reel strip again. A second box 430 indicated with dotted lines refer to an example in which the game providing apparatus moves or rotates the virtual reel strip to locate randomly selected slots including symbols ‘CDD’ at the reference location 420. The symbols included in the located slots at the reference location 420 may be displayed on a screen of the game providing apparatus or a screen of user terminal. Each of the reels of the virtual reel strip may be moved or rotated respectively to convert symbols to be displaying at the reference location 420. In this example, since the movement or rotation is not displayed to a user, it is difficult for the user to verify all combinations of the reel strip. Also, if the reel strip moves or rotates at a random location at all times for progress of a game, it is possible to uniformly maintain an entire payout rate of the game.

The virtual reel strip may be regenerated and provided for each user.

The game providing apparatus configured in a form of an electronic device may regenerate and provide a reel strip whenever a user using the game providing apparatus changes. For example, the game providing apparatus may include a sensor, e.g., a proximity sensor to detect a change of a user. If the change of the user is detected using the sensor, the game providing apparatus may regenerate and provide a new reel strip.

According to an exemplary embodiment, the game providing apparatus configured in a form of an online game, as a server that provides a slot machine game, may regenerate a reel strip and provide the regenerated reel strip to a terminal of a user whenever the user logs in.

If a reel strip is generated so that the same patterns of symbols appear in succession, an unintended stack may appear. Accordingly, the game providing apparatus may regenerate a reel strip to prevent the same pattern of symbols from reappearing in succession when regenerating the reel strip.

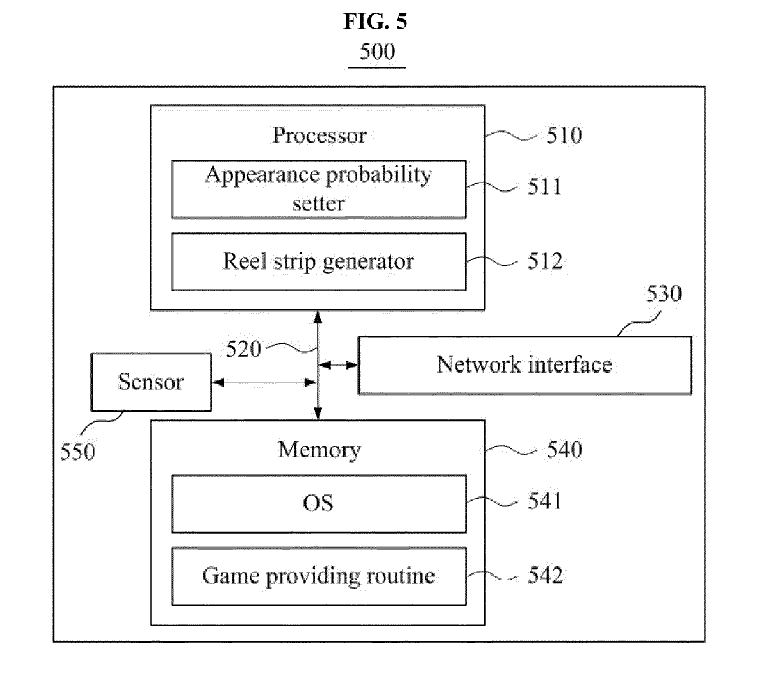

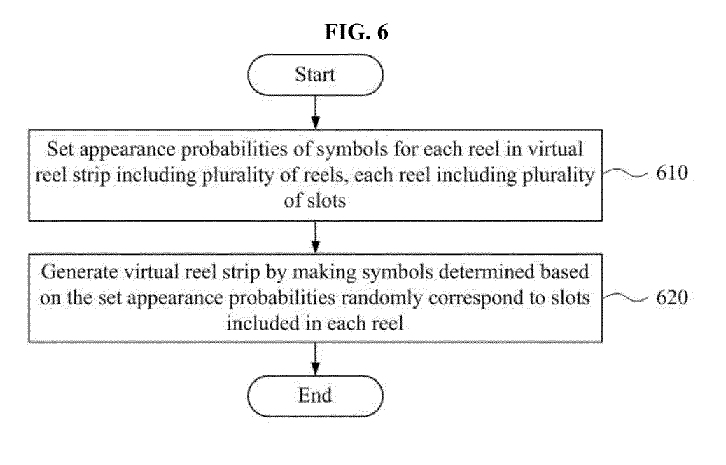

FIG. 5 is a block diagram illustrating a configuration of a game providing apparatus configured in a form of an electronic device according to an exemplary embodiment, and FIG. 6 is a flowchart illustrating a game providing method according to an exemplary embodiment.

Referring to FIG. 5, the game providing apparatus 500 may include a processor 510, a bus 520, a network interface 530, and a memory 540. The memory 540 may include an operating system (OS) 541 and a game providing routine 542. The processor 510 may include an appearance probability setter 511 and a reel strip generator 512. According to an exemplary embodiment, the game providing apparatus 500 may include more constituent elements than the constituent elements explicitly illustrated in FIG. 5. The game providing apparatus 500 may include other constituent elements such as a display when the game providing apparatus 500 is configured in a form of an electronic device, and a transceiver when the game providing apparatus 500 is configured in a form of an online game.

The memory 540, as non-transitory computer readable media, may include a permanent mass storage device such as random access memory (RAM), read only memory (ROM), and a disk drive. Also, a program code for the OS 541 and the game providing routine 542 may be stored in the memory 540. The software constituent elements may be loaded from non-transitory computer-readable media separate from the memory 540 using a drive mechanism (not shown). The non-transitory computer-readable media may include computer-readable media such as a floppy disk, a tape, a DVD/CD-ROM drive, and a memory card. According to an exemplary embodiment, the software constituent elements may be loaded to the memory 540 through the network interface 530, instead of using the non-transitory computer readable media. For example, the game providing routine 542 may be loaded to the memory 540 based on a program installed by files provided from developers over a network.

The bus 520 may enable communication and data transmission between the constituent elements of the game providing apparatus 500. The bus 520 may be configured using a high-speed serial bus, a parallel bus, a storage area network (SAN), and/or other appropriate communication technologies.

The network interface 530 may be a computer hardware constituent element to connect the game providing apparatus 500 to a computer network. The network interface 530 may connect the game providing apparatus 500 to the computer network through a wireless or wired connection.

The processor 510 may be configured to process an instruction of a computer program by performing a basic arithmetic and logic operation, and an input/output (I/O) operation of the game providing apparatus 500. The instruction may be provided from the memory 540 or the network interface 530 to the processor 510 through the bus 520. The processor 510 may be configured to execute a program code for the appearance probability setter 511 and the reel strip generator 512. The program code may be stored (e.g., the game providing routine 542) in a storage device such as the memory 540.

The appearance probability setter 511 and the reel strip generator 512 may be configured to perform operations 610 and 620 of FIG. 6, which will be described hereinafter.

In operation 610, the appearance probability setter 511 may set appearance probabilities of symbols for each reel in a virtual reel strip including a plurality of reels, each reel including a plurality of slots. The appearance probability is described with reference to Table 1 and FIG. 2 and FIG. 3.

In operation 620, the reel strip generator 512 may generate the virtual reel strip by generating symbols determined based on the set appearance probabilities randomly correspond to or assigned to slots included in each reel.

According to an exemplary embodiment, the virtual reel strip may be regenerated for each user.

For example, when the game providing apparatus 500 is configured in a form of an electric device, the game providing apparatus 500 may further include a sensor 550 to detect a change of a user. For example, the sensor 550 may include a proximity sensor and a pressure sensor, and may detect that the user is changed when a single user connects to the game providing apparatus 500 and plays a game. To this end, in addition to operations 610 and 620 of FIG. 6, the game providing apparatus 500 and method may further include an operation (not shown) of detecting a change of a user through a sensor 550 included in the game providing apparatus 500, and an operation (not shown) of regenerating the virtual reel strip in response to detecting the change of the user. The operation of detecting the change of the user may be performed by a user change detector (not shown), which may be further included in the processor 510. The operation of regenerating the virtual reel strip may be processed by repeating operations 610 and 620 using the appearance probability setter 511 and the reel strip generator 512.

Accordingly to an exemplary embodiment, if the game providing apparatus 500 is configured in a form of an online game, the game providing apparatus 500 may regenerate the virtual reel strip for the user whenever the user connects to the game providing apparatus 500 and logs in. The regeneration of the virtual reel strip may include at least one of resetting the appearance probabilities of the symbols for each reel and rearranging the symbols for each reel randomly to correspond to the slots included in the respective reel.

Further, if the game providing apparatus 500 is configured in a form of an electronic device, the game providing apparatus 500 may display a portion of combinations of symbols determined based on the generated virtual reel strip on a screen of the game providing apparatus 500. To this end, the game providing method may further include an operation (not shown) of displaying a portion of combinations of the symbols determined based on the generated virtual reel strip on a screen of the game providing apparatus 500. This operation of displaying the portion of combinations may be performed by a symbol combination display (not shown), which may be further included in the processor 510.

If the game providing apparatus 500 is configured in a form of an online game, the game providing apparatus 500 may provide the generated virtual reel strip to a terminal (not shown) of a user. In this example, a portion of combinations of symbols determined based on the virtual reel strip may be displayed on a screen of the terminal of the user. To this end, the game providing method may further include an operation (not shown) of providing the generated virtual reel strip to the terminal of the user. This operation may be performed by a reel strip provider (not shown), which may be further included in the processor 510.

In a slot machine game provided from the game providing apparatus 500, a game may proceed through a combination of symbols located at a reference location according to a movement or a rotation of a virtual reel strip in response to an input of a user. Here, the movement or the rotation of the virtual reel strip may start from a state in which a slot randomly selected from the slots included in the virtual reel strip is located at the reference location. As described above with reference to FIG. 4, the virtual reel strip may move or rotate to locate randomly selected slots at a reference location for each movement or rotation of the virtual reel strip.

As described above, according to an exemplary embodiment, it is possible to provide a game in which users may not verify all combinations of a reel strip, when generating a reel strip based on a predetermined pattern, by regenerating and thereby providing the reel strip for each user. Also, when generating and providing a reel strip for each standard, it is possible to uniformly maintain an entire payout rate.

The processes and methods may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present disclosure, or they may be of the kind well-known and available to those having skill in the computer software arts in part. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A game providing method executed by a game providing apparatus, the method comprising:
setting, by an appearance probability setter, appearance probabilities of symbols for each reel in a virtual reel strip, the virtual reel strip comprising a plurality of reels, each of the plurality of reels comprising a plurality of slots, respectively;
generating, by a reel strip generator, the virtual reel strip by allocating symbols determined based on the set appearance probabilities, the symbols for each reel being arranged randomly to correspond to slots included in the respective reel; and
providing the generated virtual reel strip to be displayed at a display, the generated virtual reel strip being configured to spin and stop each reel in response to a spin request signal,
wherein the virtual reel strip is regenerated for each user.

2. The method of claim 1, further comprising:
detecting a change of a user through a sensor included in the game providing apparatus; and
regenerating the virtual reel strip in response to detecting the change of the user, the regenerating of the virtual reel strip comprising at least one of resetting the appearance probabilities of the symbols for each reel and rearranging the symbols for each reel randomly to correspond to the slots included in the respective reel.

3. The method of claim 1, further comprising:
regenerating the virtual reel strip for a user every time the user logs in to play a slot machine game using a terminal.

4. The method of claim 1, further comprising:
displaying a portion of combinations of symbols determined based on the generated virtual reel strip on a screen of the game providing apparatus.

5. The method of claim 1, further comprising:
providing the generated virtual reel strip to a terminal of a user,
wherein a portion of combinations of symbols determined based on the virtual reel strip is displayed on a screen of the terminal of the user.

6. The method of claim 1, wherein a game proceeds through a combination of symbols located at a reference location according to a movement or a rotation of the virtual reel strip in response to an input of a user, and
the movement or the rotation of the virtual reel strip starts from a state in which a slot randomly selected from the slots included in the virtual reel strip is located at the reference location.

7. A game providing method executed by a game providing apparatus, the method comprising:
setting, by an appearance probability setter, appearance probabilities of symbols for each reel in a virtual reel strip, the virtual reel strip comprising a plurality of reels, each of the plurality of reels comprising a plurality of slots, respectively;
generating, by a reel strip generator, the virtual reel strip by allocating symbols determined based on the set appearance probabilities, the symbols for each reel being arranged randomly to correspond to slots included in the respective reel; and
providing the generated virtual reel strip to be displayed at a display, the generated virtual reel strip being configured to spin and stop each reel in response to a spin request signal,
wherein the virtual reel strip is regenerated for a same user every time the same user logs in.

8. A non-transitory computer-readable medium having stored thereon processor-executable instructions that causes a slot game providing apparatus comprising a processor to perform the method of claim 1.

9. A game providing apparatus comprising:
an appearance probability setter configured to set appearance probabilities of symbols for each reel in a virtual reel strip, the virtual reel strip comprising a plurality of reels, each of the plurality of reels comprising a plurality of slots, respectively;
a reel strip generator configured to generate the virtual reel strip by allocating symbols determined based on the set appearance probabilities, the symbols for each reel being arranged randomly to correspond to slots included in the respective reel; and
a reel strip provider configured to provide the generated virtual reel strip to be displayed at a display, the generated virtual reel strip being configured to spin and stop each reel in response to a spin request signal,
wherein the virtual reel strip is regenerated for each user.

10. The game providing apparatus of claim 9, further comprising:
at least one sensor; and
a user change detector configured to detect a change of a user through the at least one sensor,
wherein in response to detecting the change of the user, the reel strip generator is configured to regenerate the virtual reel strip, the regeneration of the virtual reel strip comprising at least one of resetting the appearance probabilities of the symbols for each reel and rearranging the symbols for each reel randomly to correspond to the slots included in the respective reel.

11. The game providing apparatus of claim 9, wherein the virtual reel strip for a user is regenerated every time the user logs in to play a slot machine game using a terminal.

12. The game providing apparatus of claim 9, further comprising:
a symbol combination display configured to display a portion of combinations of symbols determined based on the generated virtual reel strip on a screen of the game providing apparatus.

13. The game providing apparatus of claim 9, wherein the reel strip provider is configured to provide the generated virtual reel strip to a terminal of a user, and
wherein the terminal of the user is configured to display a portion of combinations of symbols determined based on the virtual reel strip on a screen of the terminal.

14. The game providing apparatus of claim 9, wherein a game proceeds through a combination of symbols located at a reference location according to a movement or a rotation of the virtual reel strip in response to an input of a user, and
the movement or the rotation of the virtual reel strip starts from a state in which a slot randomly selected from the slots included in the virtual reel strip is located at the reference location.

15. A game providing apparatus comprising:
an appearance probability setter configured to set appearance probabilities of symbols for each reel in a virtual reel strip, the virtual reel strip comprising a plurality of reels, each of the plurality of reels comprising a plurality of slots, respectively;
a reel strip generator configured to generate the virtual reel strip by allocating symbols determined based on the set appearance probabilities, the symbols for each reel being arranged randomly to correspond to slots included in the respective reel; and
a reel strip provider configured to provide the generated virtual reel strip to be displayed at a display, the generated virtual reel strip being configured to spin and stop each reel in response to a spin request signal,
wherein the virtual reel strip is regenerated for a same user every time the same user logs in.
